(19) United States
(12) Patent Application Publication
(10) Pub. No.: US 2003/0150963 A1
(43) Pub. Date: Aug. 14, 2003

(54) Hose anchor assembly

(76) Inventor: Alejandro Doring, La Jolla, CA (US)

Correspondence Address: Shepard, Mullin, Richter & Hampton LLP, 48th Floor, 333 South Hope Street, Los Angeles, CA, 90071-1448, US

(21) Appl. No.: 10/075,677

(22) Filed: Feb. 13, 2002

(51) Int. Cl. A62C 13/76; B05B 15/06

(52) U.S. Cl. 248/76

(57) ABSTRACT

A hose anchor assembly for protecting a hose bib and an exterior wall of a building from damage and undue wear resulting from excessive force applied by a user of a hose connected to the hose bib. Without benefit of the present invention, forces applied to the hose by the user would be borne by the hose bib and the hose, particularly at its attachment end. However, the anchor assembly buffers these forces and diverts them away from the hose bib. Moreover, the anchor assembly is relatively inexpensive to manufacture and reliable in use. The hose anchor assembly includes a hose fastener for detachable securement of the hose and an anchor for providing stationary positioning of the assembly. The assembly also includes a resilient member, such as a helical spring, disposed between the fastener and the anchor to aid in buffering forces exerted by the user on the hose from the hose bib.

### BACKGROUND OF THE INVENTION

This invention relates generally to lawn and garden hose accessories and, more particularly, to water-hose anchor assemblies.

Residential and commercial buildings often have a faucet, i.e., hose bib, mounted on an exterior wall to make water available for use around the building. As is commonly known, a water hose has a first end, which is securely attached to the hose bib, and a free end, which dispenses water provided by the hose bib. The hose is used to dispense water for a variety needs, such as, watering plants and foliage, washing an automobile, and the like. The user holds the hose at the free end and drags it to an area where the water is needed.

In transport to the desired destination, the hose can become fully extended or tangled on an object. Nevertheless, the user of the hose may continue to tug on the hose, applying forces to the hose which may be borne by the hose bib and the hose, particularly at its attachment end. Repeated tugging can cause undue wear on the attachment end of the hose, the hose bib and the exterior wall of the building. In some instances, if the user is not mindful of the force applied to the hose and the hose bib, substantial damage may result. For example, the hose bib can become detached from the exterior wall and/or the water pipe within the exterior wall. Also, the attachment end of the hose be damaged causing excessive leaking and requiring replacement of the hose.

It should, therefore, be apparent that there is a need for a hose anchor configured to protect the hose, the hose bib and the external wall from damage resulting from a user applying an excessive force on the hose, which is relatively inexpensive to manufacture and reliable in use. The present invention fulfills this need and others.

### SUMMARY OF THE INVENTION

The present invention provides a hose anchor assembly for protecting a hose, a hose bib and an exterior wall of a building from damage and undue wear resulting from excessive force exerted by a user of a hose connected to the hose bib. Without benefit of the present invention, forces applied on the hose by the user would be borne by the hose bib and the attachment end of the hose. However, the anchor assembly buffers these forces and diverts them away from the hose bib. Moreover, the anchor assembly is relatively inexpensive to manufacture and reliable in use. The hose anchor assembly includes a hose fastener for detachable securement of the hose and an anchor for providing stationary positioning of the assembly. The assembly also includes a resilient member, such as a helical spring, disposed between the fastener and the anchor to aid in buffering forces exerted by the user on the hose from the hose bib.

In a detailed feature of a preferred embodiment, the hose fastener includes a first jaw and a second jaw in opposed relationship to one another with confronting curved surfaces configured to securely conform to the hose.

In another detailed feature of a preferred embodiment, the anchor includes an upper portion attached to the resilient member and a lower portion configured to be driveable into the ground and to provide stationary positioning once therein. Preferably, the lower portion is an elongated stake having a longitudinal axis and a plurality of flanges protruding outward relative to the longitudinal axis.

In another preferred embodiment, the anchor is embodied in a securement plate for mounting on a hard surface such as concrete, wood, or cement provided with a plurality of holes sized to receive a securing device appropriate for the surface.

Other features and advantages of the invention should become apparent from the following description of the preferred embodiments, taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings in which:

FIG. 1 is an elevational view of an exterior wall with a hose bib, a hose, and a hose anchor assembly attached to the hose, according to a preferred embodiment of the present invention;

FIG. 2 is a side elevational view of the hose anchor assembly depicted in FIG. 1;

FIG. 3 is a front elevational view of the hose anchor assembly depicted in FIG. 1;

FIG. 4 is a rear elevational view of the hose anchor assembly depicted in FIG. 1; and

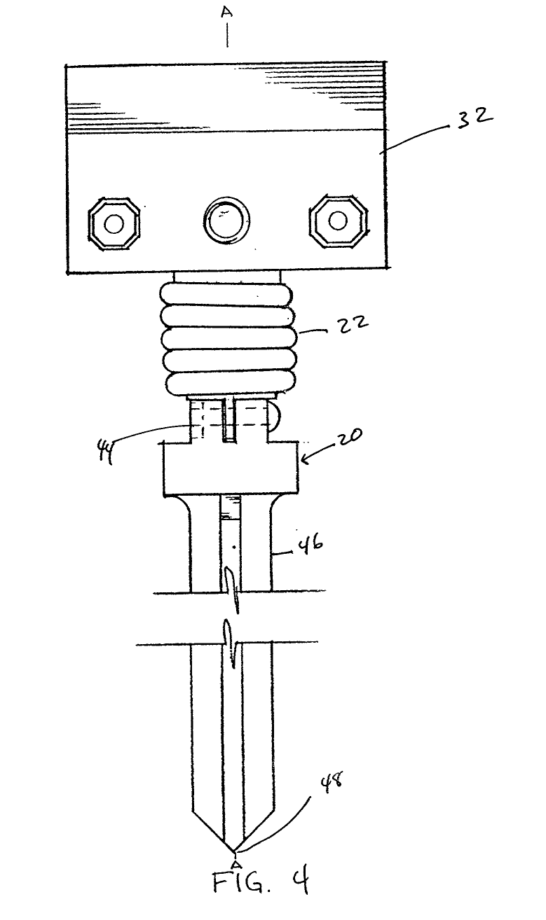

FIG. 5 is an oblique perspective view of a second preferred embodiment of a hose anchor assembly according to the present invention.

### DESCRIPTION OF THE PREFERRED EMBODIMENTS

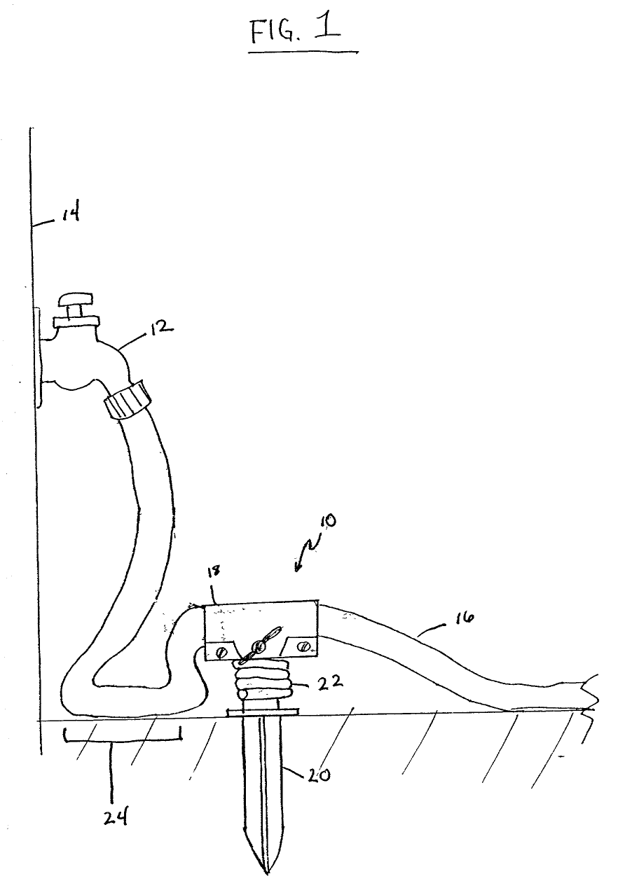

In this section, the present invention is described in detail with regard to the figures briefly described above. With reference to FIG. 1, there is shown an elevational view depicting a preferred embodiment of the invention in a hose anchor assembly 10 for protecting a hose bib 12 and an exterior wall 14 of a building from damage and undue wear resulting from excessive force applied by a user (not shown) of a hose 16 connected to the hose bib at an attachment end. Without benefit of the present invention, forces applied to the hose by the user can sometimes be borne solely by the hose bib or in combination with the attachment end of the hose. However, the anchor assembly buffers these forces and diverts them away from the hose bib. Beneficially, the anchor assembly is reliable in use and relatively inexpensive to manufacture.

With continued reference to FIG. 1, the hose anchor assembly 10 includes a hose fastener 18 securable to the hose 16 and an anchor 20 for providing stationary positioning of the assembly. The assembly is also provided with a resilient member 22 disposed between the fastener and the anchor, which aids in buffering forces applied by the user on the hose from the hose bib. Preferably, the anchor assembly is attached to the hose in proximity to the hose bib 12 and is securely inserted into the ground adjacent thereto. In this configuration, it is advisable to provide sufficient slack 24 in the hose between the hose bib and the anchor assembly to accommodate for some movement of the hose fastener relative to the anchor when force is applied to the hose.

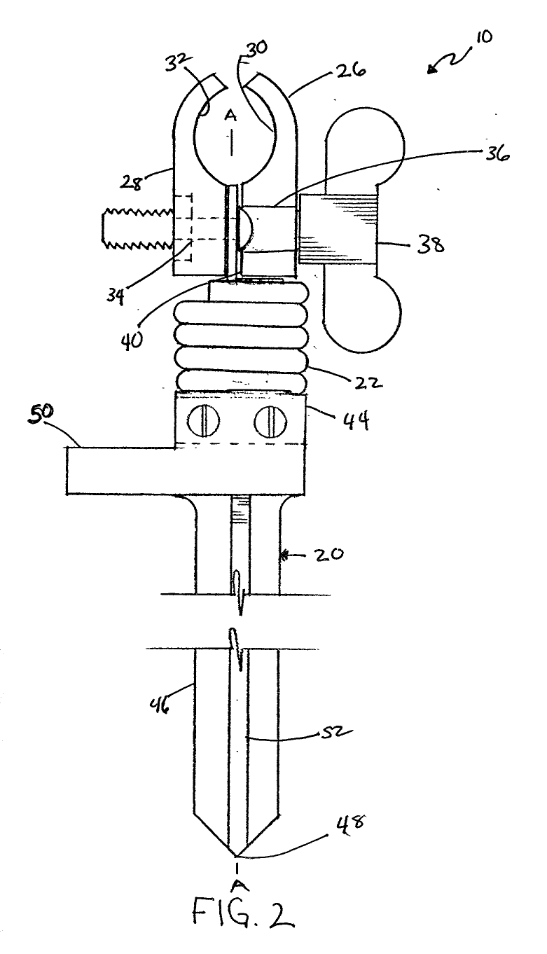

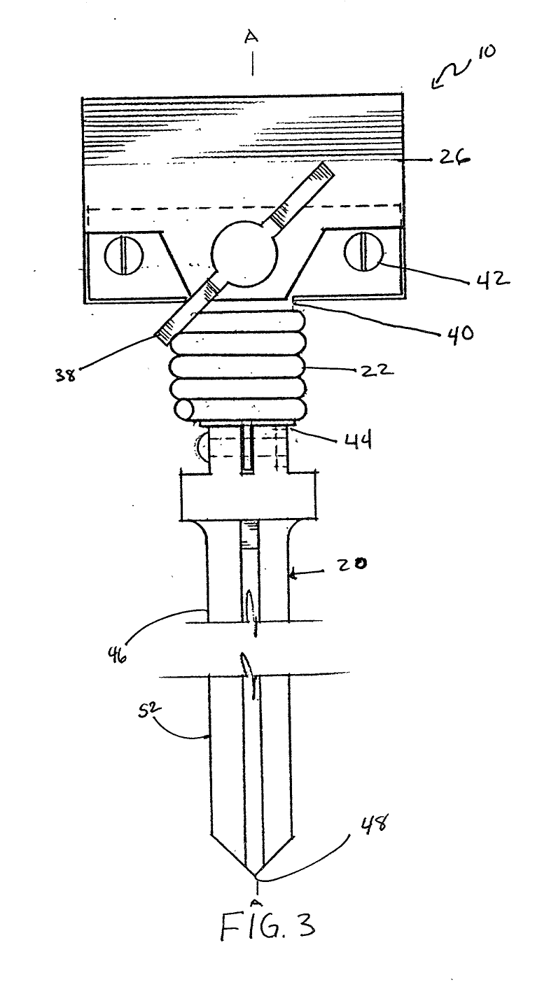

With reference to FIGS. 2 and 3, the hose fastener 18 is configured to adjustably hold various sized hoses. As best seen in FIG. 2, the hose fastener includes a stationary jaw 26 and an adjustable jaw 28 in opposed relationship to one another with facing inner curved surfaces 30 and 32, respectively, adapted to snugly conform to the hose 16. In other preferred embodiments, the inner surfaces may further define ridges, cleats, or other like gripping treads. The adjustable jaw defines an internally-threaded hole 34 aligned with a hole 36 defined by the stationary jaw. The fastener further includes a butterfly screw 38 extending through the hole in the stationary jaw and treaded into the hole of the adjustable jaw. The butterfly screw allows the fastener to easily adjust to fit hoses of various sizes and to secure and release the hose. The stationary jaw includes a base 40 adapted to securely attach to the resilient member 22. Referring now to FIG. 3, nuts-and-bolts 42 are used to secure the resilient member to the base. The fastener is preferably made of plastic for cost effectiveness and durability. In other embodiments, other fasteners may be used, e.g., adjustable sleeves, clips, spring-loaded clamps, and the like.

The resilient member 22 is configured to buffer forces applied to the hose 16 by the user. The resilient member is preferably configured as a helical spring formed of a heavy gauge metal and is attached at its upper end to the base 40 of the hose fastener and at its lower end to an upper portion 44 the anchor 20. In a preferred embodiment, the resilient member is further coated with a plastic or rubber material to avoid rusting as well as pinching-type accidents. In other embodiments, the resilient member may incorporate other configurations and materials sufficient to buffer excessive force from the hose bib, e.g., spring-bushing configurations, a movable joint deposed in a damping fluid, resilient plastic or rubber material, and the like.

With continued reference to FIG. 2, the anchor 20 is configured for easy insertion into the ground and is further configured to resist rotation or inadvertent dislodging once inserted. More particularly, the anchor includes an elongated stake 46 terminating in a pointed end 48 and further includes a driving tab 50 projecting from the upper portion 44 of the anchor, to aid in inserting the anchor into the ground. Additionally, the stake is about 8 inches long, and is provided with flanges 52 configured to resist rotation or inadvertent dislodging of the spike, once inserted into the ground. The stake is preferably formed of a rugged plastic material having sufficient characteristics to withstand excessive forces, such as those which may be encountered. In this embodiment, the stake has four flanges equally spaced from one another, protruding approximately ½ inch from a reference longitudinal axis (A-A) of the anchor. In other embodiments, alternative configurations for the anchor may be used for securing the anchor to the ground, e.g., cylindrical, frusto-conical, V-shaped cross section, multiple spikes, and the like.

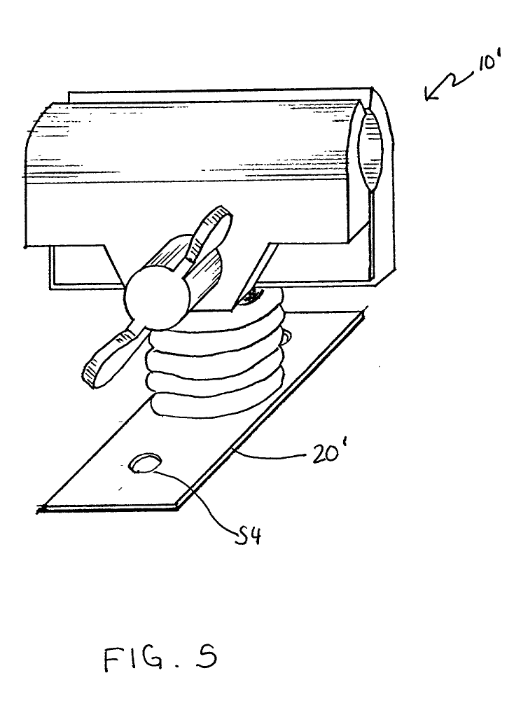

FIG. 5 an oblique perspective view of a second preferred embodiment of a hose anchor assembly 10′ having an anchor 20′ configured to be secured to an external wall, a house foundation, a sidewalk, or the like. In this instance, the anchor is generally planar and provides holes 54 for securing the anchor in place by means commonly known in the art, e.g. bolts, nails, screws, and the like. In other embodiments, the anchor can be adapted to conform to a selected mounting surface, such as, curved surfaces.

From the forgoing, it will be appreciated that the hose anchor assembly of the invention provides a hose anchor configured to protect the hose, the hose bib and the external wall from damage resulting from a user exerting excessive force on the hose. Without benefit of the present invention, forces applied on the hose by the user would be borne by the hose bib and the attachment end of the hose. However, the anchor assembly buffers these forces and diverts them away from the hose bib. Moreover, the anchor assembly is relatively inexpensive to manufacture and reliable in use. Although the invention has been described with reference only to the preferred embodiments, those skilled in the art will appreciate that various modifications can be made without departing from the invention. Accordingly, the invention is defined only by the following claims.

I claim:

1. A hose anchor assembly for use with a water hose attached to a hose bib comprising:
a hose fastener having a base and configured to detachably and securely clench a segment of the water hose;
a resilient member having a first attachment region secured to the base of the hose fastener and a second attachment region; and
an anchor secured to the second attachment region of the resilient member and configured to provide stationary positioning relative to the hose bib.

2. A hose anchor assembly as defined in claim 1, wherein the hose fastener includes a first jaw and a second jaw in opposed relationship to one another with confronting curved surfaces configured to securely conform to the hose.

3. A hose anchor assembly as defined in claim 1, wherein the resilient member is a helical spring.

4. A hose anchor assembly as defined in claim 1, wherein the anchor includes a securement plate for mounting on a hard surface such as concrete, wood, or cement provided with a plurality of holes sized to receive a securing device appropriate for the surface.

5. A hose anchor assembly as defined in claim 1, wherein the anchor includes an upper portion attached to the resilient member and a lower portion configured to be driveable into the ground and to provide stationary positioning once therein.

6. A hose anchor assembly as defined in claim 5, wherein the lower portion of the anchor is an elongated stake having a longitudinal axis and a plurality of flanges protruding outward relative to the longitudinal axis.

7. A hose anchor assembly for use with a water hose attached to a hose bib comprising:
a hose fastener having a base and configured to detachably and securely clench a segment of the water hose;
a spring having a first attachment region secured to the base of the hose fastener and a second attachment region; and
an anchor secured to the second attachment region of the spring and configured to provide stationary positioning relative to the hose bib.

8. A hose anchor assembly as defined in claim 7, wherein the hose fastener includes a first jaw and a second jaw in opposed relationship to one another with confronting curved surfaces configured to securely conform to the hose.

9. A hose anchor assembly as defined in claim 7, wherein the resilient member is a helical spring.

10. A hose anchor assembly as defined in claim 7, wherein the anchor includes a securement plate for mounting on a hard surface such as concrete, wood, or cement provided with a plurality of holes sized to receive a securing device appropriate for the surface.

11. A hose anchor assembly as defined in claim 7, wherein the anchor includes an upper portion attached to the resilient member and a lower portion configured to be driveable into the ground and to provide stationary positioning once therein.

12. A hose anchor assembly as defined in claim 11, wherein the lower portion of the anchor is an elongated stake having a longitudinal axis and a plurality of flanges protruding outward relative to the longitudinal axis.

13. A hose anchor assembly for use with a water hose attached to a hose bib comprising:
a hose fastener, configured to detachably and securely clench a segment of the water hose, having
a base,
a first jaw adjacent to the base and having an inner curved surface, and
a second jaw in opposed relationship to the first jaw with an inner curved surface confronting the curved surface of the first jaw;
a resilient member having a first attachment region secured to the base of the hose fastener and a second attachment region; and
an anchor secured to the second attachment region of the resilient member and having a lower portion configured to be driveable into the ground and to provide stationary positioning once therein.

14. A hose anchor assembly as defined in claim 13, wherein the resilient member is a spring.

15. A hose anchor assembly as defined in claim 13, wherein the lower portion of the anchor is an elongated stake having a longitudinal axis and a plurality of flanges protruding outward relative to the longitudinal axis.

16. A hose anchor assembly as defined in claim 15, wherein the flanges are equally spaced about the longitudinal axis.
